(19) United States
(12) Patent Application Publication
(10) Pub. No.: US 2011/0162507 A1
(43) Pub. Date: Jul. 7, 2011

(54) FINE TUNING PEG

(76) Inventor: Adelbert Lauffer, Reutlingen (DE)

(21) Appl. No.: 13/054,281

(22) PCT Filed: Jul. 15, 2009
(86) PCT No.: PCT/EP09/59025

§ 371 Date: Mar. 3, 2011

(30) Foreign Application Priority Data
Jul. 15, 2008 (DE) 10-2008-033-190.2

(51) Int. Cl. G10D 3/14

(52) U.S. Cl. 84/304

(57) ABSTRACT

The invention relates to a tuning device for setting the tension of one or more strings on a stringed instrument, comprising a peg receiving portion (10), which has pairs of bores (14) for rotatably receiving tuning pegs (20), wherein the tuning pegs (20) in each case comprise a peg body with a spindle (26) for insertion into a pair of bores (12, 14) in the peg receiving portion (10) and for winding up the end portion of a string and a peg grip (22), connected to the spindle (26), for turning the spindle (26) about a common axis (a) of the peg grip (22) and the spindle (26). A gear mechanism (33) is provided outside the peg receiving portion (10), functionally between the peg grip (22) and the spindle (26), and passes on to the spindle (26) a turning movement of the peg grip (22) about the common axis (a) that is reduced in its magnitude, wherein the gear mechanism (33) is an eccentric gear mechanism.

The invention relates to a tuning device for adjusting the tension of one or more strings of a stringed instrument, with a peg receiving portion which comprises pairs of bores for rotatably receiving tuning pegs, the tuning pegs in each case comprising a peg body with a spindle for insertion into a pair of bores in the peg receiving portion and for winding up the end portion of a string and comprising a peg handle joined to the spindle for turning the spindle about a common axis of peg handle and spindle, a gear mechanism being provided outside the peg receiving portion for function between the peg handle and the spindle, which gear mechanism passes on to the spindle a geared-down turning movement of the peg handle about the common axis.

Such tuning devices with a gear mechanism for gearing down a turning movement on the peg handle to the spindle connected to a string are known in the prior art. Use of a reduction gear mechanism allows high-precision tuning of the string. In addition, the gear mechanism may at the same time also prevent the undesired effect of jerky peg turning, which frequently occurs with conventional tuning devices without a gear mechanism when the peg undergoes a change from static to sliding friction at the start of turning.

It is generally advantageous for the tuning pegs with a reduction gear mechanism to be dimensioned such that they may be fitted in traditional stringed instruments without the latter having to be modified, in particular without the bores in the peg receiving portion, which serve to receive the tuning pegs, having to be enlarged. In addition the fitting operation is greatly simplified if conventional tools can be used to mount the tuning pegs in the peg receiving portion.

Because of these desired characteristics and also for aesthetic reasons relating to the appearance of the instrument, it is advantageous for a modern tuning peg with a gear mechanism, which will hereinafter be designated “fine tuning peg” for short, roughly to correspond in its external dimensions to a traditional tuning peg. However, this entails the problem that only very limited structural space is available for arranging the reduction gear mechanism in the fine tuning peg and the individual gear elements have to be of correspondingly small construction. In view of the not inconsiderable forces which have to be applied when tightening a string, appropriately high quality and thus expensive materials have to be used for the gear elements, so that despite their small size they exhibit the strength needed to be able to transmit the forces.

An essential step in solving this problem consists in arranging the reduction gear mechanism not, as is generally conventional, in the region of the peg receiving portion, but instead in the region of the peg handle, where the tuning peg may have a larger diameter. This makes it possible to provide the gear mechanism with more structural space, such that the individual gear elements may be larger in size and may consequently be made of less expensive materials, such as in particular plastics, without the peg receiving portion of the stringed instrument having to be modified. Such a tuning device is known for example from DE 20 2007 001 518 U1, which originates from the same applicant.

In particular, a tuning device is known from DE 20 2007 001 518 U1, which discloses a planetary gear mechanism, which is arranged outside of the portion of the tuning peg inserted into the peg receiving portion. However, despite the larger size of the reduction gear mechanism, it has become clear in practice that when inexpensive materials are used for the gear elements wear problems may still arise, in particular when the fine tuning peg is used for a long time.

It is therefore the object of the present invention to provide a tuning device of the above-mentioned type which allows the use of inexpensive materials for a reduction gear mechanism and at the same time prevents or at least markedly reduces wear phenomena on the gear elements. It is also intended that the tuning device be suitable for use in stringed instruments of conventional structure without these having to be modified appreciably, and/or without unconventional tools being needed therefor.

This object is achieved according to the invention by a tuning device of the above-mentioned type, in which the gear mechanism is an eccentric gear mechanism.

Although this solution appears surprisingly simple, it is very effective. The essential advantage of this tuning device consists in the fact that, due to the use of an eccentric gear mechanism, larger gear elements may be used in the same structural space than is possible with a planetary gear mechanism, as is disclosed in DE 20 2007 001 518 U1. Due to the particular structure of a planetary gear the diameter of the individual planetary wheels, via which the force is transmitted from the peg handle to the spindle of the fine tuning peg, can be no greater than the distance between the toothing of the output spur gear and the common axis of peg handle and spindle. In contrast, a corresponding hollow pinion mounted on an eccentric in an eccentric gear mechanism may have an external diameter which corresponds to approximately twice the above-stated distance. This results in it being possible to transmit the force in an eccentric gear mechanism by way of larger hollow pinion teeth. Thus the mechanical stress on the teeth is reduced and the life expectancy of the gear mechanism is increased significantly.

In addition the eccentric gear mechanism has the advantage over a planetary gear mechanism that it manages with just one hollow pinion instead of a plurality of planetary gears, such that the number of gear mechanism parts is reduced. This leads to reduced complexity and costs with regard to manufacture and assembly and also has a positive effect on the probability of failure of the gear mechanism.

In an advantageous configuration the eccentric gear mechanism comprises an eccentric shaft which may be turned about the common axis by a turning movement of the peg handle, a hollow pinion mounted rotatably on the eccentric shaft, a first internal gear toothing arranged non-rotatably relative to the peg receiving portion and a second internal gear toothing arranged non-rotatably relative to the spindle, wherein a first hollow pinion portion of the hollow pinion is in toothed engagement with the first internal gear toothing and a second hollow pinion portion of the hollow pinion adjoining the first hollow pinion portion in the direction of the common axis is in toothed engagement with the second internal gear toothing. The eccentric gear mechanism may take the form of a stepped eccentric gear mechanism, i.e. between the first hollow pinion portion and the second hollow pinion portion a step is formed radially on the hollow pinion relative to the common peg handle and spindle axis. If the eccentric gear mechanism takes the form of a stepped eccentric gear mechanism, the external toothing of the first hollow pinion portion and the external toothing of the second hollow pinion portion comprise different numbers of teeth, which provides great flexibility when selecting the suitable reduction ratio.

In a particularly advantageous further configuration the difference in numbers of teeth between the first internal gear toothing and the external toothing of the first hollow pinion portion is equal to the difference in numbers of teeth between the second internal gear toothing and the external toothing of the second hollow pinion portion. In contrast to an eccentric gear mechanism with an equal number of teeth on the first and second hollow pinion portions, this makes it possible to achieve a relatively large engagement factor both for the first gear stage, which is defined by the first hollow pinion portion and the first internal gear toothing, and for the second gear stage, which is defined by the second hollow pinion portion and the second internal gear toothing. The greater is the engagement factor of a gear stage, the greater is the number of teeth which engage with one another simultaneously, and the greater also is the transmittable force or the better the force to be transmitted can be distributed. For example, the first hollow pinion portion could comprise nineteen teeth, the first internal gear toothing could comprise twenty-four teeth, the second hollow pinion portion could comprise fifteen teeth and the second internal gear toothing twenty teeth. For the two gear stages there would thus be a difference in number of teeth of five between the corresponding hollow pinion portion and the corresponding internal gear toothing, which for the two gear stages leads to a relatively large engagement factor of more than 1.4.

To be able to make optimal use of the available fine tuning peg structural space, it is advantageous for the peg handle to comprise a recess in which a component comprising the first internal gear toothing, and preferably also a component comprising the second internal gear toothing, is or are at least partially accommodated. To get a better grip on the peg, the peg handle is as a rule larger in the radial direction, relative to the common axis, than the rest of the fine tuning peg. Thus, the structural space available anyway in the peg handle may be used for at least partial, preferably complete, accommodation of the eccentric gear mechanism. In this respect, the dimensions of the fine tuning peg need to be changed only slightly, if at all, relative to those of a traditional tuning peg. This has a positive effect on the overall appearance of the fine tuning peg, the shape of which may be close to or even retain the conventional shape.

To prevent the tightened string from being able to turn the tuning peg itself, the string tension thereby being lost, the eccentric gear mechanism may be self-locking. Otherwise, other precautions would be needed to lock the fine tuning peg, which would result in further components and thus higher costs.

In practice it has proven particularly practical, for precision tuning of the stringed instrument, for the eccentric gear mechanism to be designed to bring about gearing down of the turning movement between peg handle and spindle by 1:12 to 1:25, preferably by between 1:18 and 1:20, still more preferably by approx. 1:19.

To be able to produce the fine tuning peg as inexpensively as possible, it is recommended that the eccentric gear mechanism be made at least in part of plastics, in particular polyamide. With appropriately large scale manufacture, the unit costs of the gear elements may in particular also be kept very low by using an injection moulding method to produce them.

If, despite the measures according to the invention, wear phenomena are still not reduced satisfactorily, or if it is desired to increase the service life expectancy of the fine tuning peg still further, the eccentric gear mechanism may be made at least in part of carbon fibre-reinforced material, the carbon fibre content preferably amounting to between 30% and 50%, still more preferably to approx. 40%. In addition, the reinforcement provided by the carbon fibres may contribute to increasing the modulus of elasticity of the parts of the fine tuning peg in such a way that the slight material damping contributes to the tonal excellence of the stringed instrument.

Provision may additionally be made for a bearing housing, inserted, preferably pressed, into the bore in the peg receiving portion between the spindle and the peg receiving portion on the side of the peg receiving portion close to the peg handle, to be arranged non-rotatably relative to the peg receiving portion, and/or for a bushing, inserted, preferably pressed, into the bore in the peg receiving portion between the spindle and the peg receiving portion on the side of the peg receiving portion remote from the peg handle, to be arranged non-rotatably relative to the peg receiving portion, wherein the spindle is mounted in the bearing housing and/or the bushing so as to be turnable with the peg handle about the common axis of rotation. In this way, mounting of the spindle is independent of the material used for the peg receiving portion, which ensures uniform friction between the spindle and the bearing housing and/or the bushing and thus movement during tuning which is largely independent of variable environmental conditions such as temperature and atmospheric humidity.

Conventionally, the bores introduced into the peg boxes of traditional stringed instruments to receive the bearing housings for tuning pegs have a diameter of around 12.5 mm when new on the side from which the tuning peg is inserted, wherein they generally taper slightly conically. Because the material surrounding the bores, generally wood, is subject to mechanical and other stresses, this diameter may increase over time. As a rule, an additional bushing is introduced into the bore once a diameter of 14.5 mm is reached. Furthermore, the peg receiving portion tapers from the body of the stringed instrument towards the scroll. Since all the pairs of bores are conventionally introduced into the peg receiving portion with the same tool, for example a conically tapering reamer, this has the consequence that the diameter of the bores where the tuning peg exits again from the peg receiving portion varies from pair of bores to pair of bores.

With regard to the two effects explained above, it may be desirable for the fine tuning peg according to the invention to be usable for the stated diameters of the bores and the range in between. This may advantageously be achieved in that the bearing housing and/or the bushing taper, preferably conically, in the direction of insertion of the tuning peg into the pair of bores in the peg receiving portion, the external diameter of the bearing housing amounting to between approx. 12.5 mm and approx. 14.5 mm. The fine tuning peg may thus be inserted to a greater or lesser depth into the bore depending on the diameter of the bore. It may in this respect be particularly advantageous for the bushing and the spindle of the fine tuning peg to be dimensioned in such a way in the direction of insertion of the tuning peg into the pairs of bores in the peg receiving portion that they project beyond the peg receiving portion on the side of the peg receiving portion remote from the peg handle. It may thus be ensured that a “standard fine tuning peg” is long enough both for insertion into a bore with a diameter of approx. 12.5 mm and into a bore with a diameter of approx. 14.5 mm. If the end of the spindle and the bushing project too far out of the peg receiving portion, they could if needed be cut to length. This is particularly straightforward, for example, if both are made of plastics. By using a “standard fine tuning peg”, the scale of manufacture may be increased and the unit costs thereof thus reduced.

To reduce the number of parts and the complexity of assembly still further, provision may be made for the component comprising the first internal gear toothing to be joined non-rotatably to the bearing housing by means of a snap closure and/or by adhesive bonding. These are very simple joining methods, which do not require any additional joining elements, such as in particular screw elements. In addition, the hook and counter-hook elements needed for a snap closure can very readily be integrally formed on injection moulded parts.

At this point it should be pointed out that the fine tuning peg according to the invention may be used with any known type of stringed instrument, i.e. for example with bowed instruments, such as violins, violas, cellos or the like, or with plucked instruments, such as guitars, zithers, harps or the like or with other types of stringed instruments, such as dulcimers or the like, to mention just a few examples.

The present invention is explained in greater detail below on the basis of an exemplary embodiment and with reference to the attached figures, in which:

FIG. 1 is a schematic side view of a peg receiving portion with just one tuning device according to the invention;

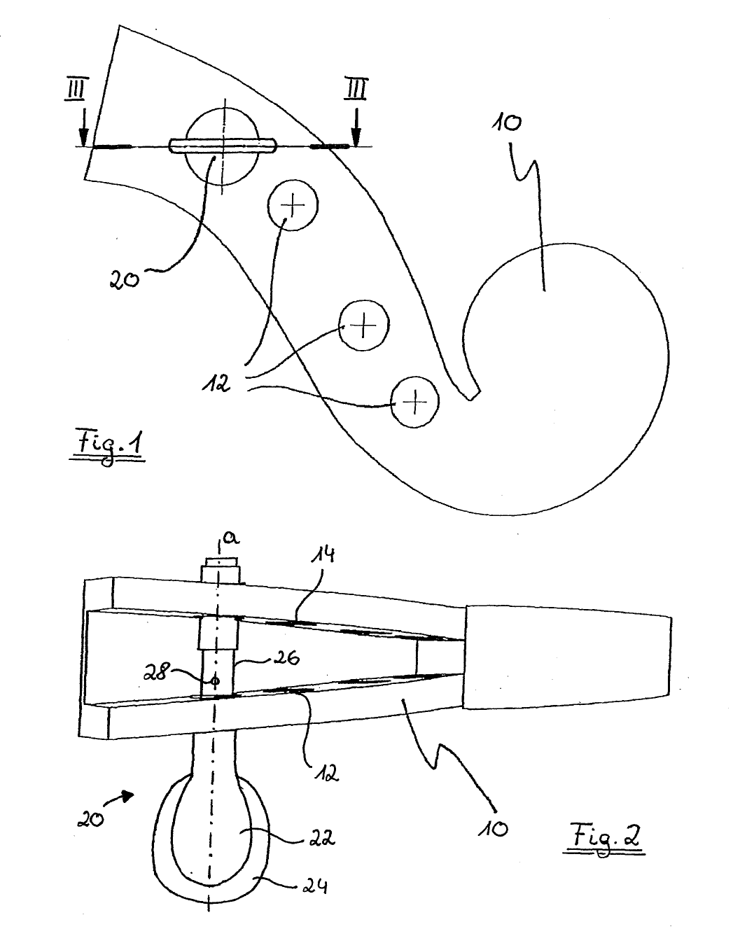

FIG. 2 is a schematic plan view of the peg receiving portion according to FIG. 1; and

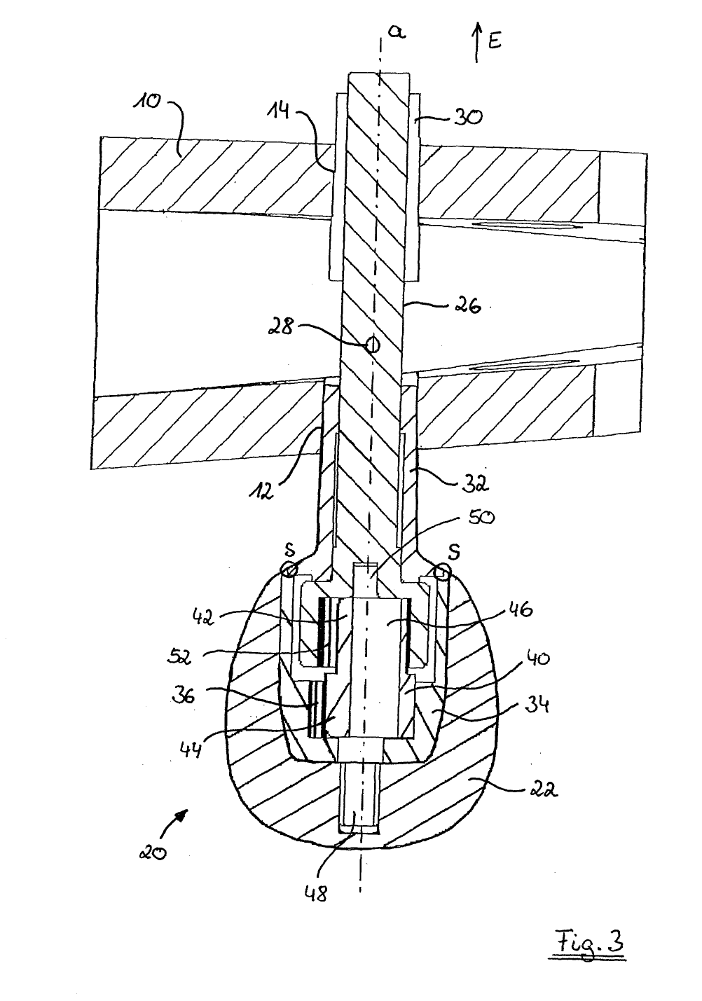

FIG. 3 shows a sectional view taken along line III-III in FIG. 1 of the peg receiving portion illustrated in FIG. 1.

The schematic side view of FIG. 1 and the schematic plan view of FIG. 2 show a peg receiving portion 10 of a stringed instrument. In the exemplary embodiment illustrated, the peg receiving portion 10 is the peg box of a bowed instrument, for example a violin. The invention may however also be used with advantage in other types of stringed instruments whose peg receiving portion is not known as a peg box.

The peg receiving portion 10 comprises a plurality of pairs of bores 12, 14, wherein a tuning peg 20 according to the invention is arranged by way of example in one of the pairs of bores 12, 14. The tuning peg 20 comprises a peg handle 22, which is provided in this exemplary embodiment with finger wings 24 to assist with gripping. The peg handle 22 allows the spindle 26 arranged on a common axis a with the peg handle 22 to be turned. Introduced into the spindle 26 is a winding hole 28, through which a string of the stringed instrument, not shown, may be introduced for tuning via the tuning device.

FIG. 3 is an enlarged view of the embodiment of the tuning device according to the invention for adjusting the tension of one or more strings of a stringed instrument in a section taken along line III-III of FIG. 1.

The two bores of the pair of bores 12, 14 are formed in such a way in the peg receiving portion 10 that they taper conically in the insertion direction E of the tuning peg 20. A bushing 30 likewise tapering in the insertion direction E of the tuning peg 20 is introduced into the bore 14 remote from the peg handle 22 and is there joined firmly, in particular non-rotatably, to the peg receiving portion 10. Similarly, a bearing housing 32 tapering in the insertion direction E of the tuning peg 20 is introduced into the bore 12 close to the peg handle 22 and is there joined firmly, in particular non-rotatably, to the peg receiving portion 10. Bushing 30 and bearing housing 32 mount the spindle 26 of the tuning peg 20 rotatably relative to the peg receiving portion 10.

The structure described below of a gear mechanism 33 of the tuning peg 20 is independent of the mounting of the latter on the peg receiving portion 10.

To form the gear mechanism 33, a component 34 comprising a first internal gear toothing 36 is attached firmly, in particular non-rotatably, to the bearing housing 32. Attachment may, as shown for this exemplary embodiment, be brought about by snap closures, not shown here, at the points S, wherein this may if desired be supplemented by adhesive bonding of the two components 32, 34. The external toothing of a first hollow pinion portion 44 of a hollow pinion 40 engages with the first internal gear toothing 36.

The hollow pinion 40 is mounted rotatably on an eccentric shaft 46. A first journal 48 at the one end of the eccentric shaft 46 is joined firmly, in particular non-rotatably, to the peg handle 22. In this exemplary embodiment the first journal 48 of the eccentric shaft 46 is inserted into a recess in the peg handle 22 and joined to the peg handle 22 for example by keying and/or by means of an adhesive bond. A second journal 50 at an opposite end of the eccentric shaft 46 from the first journal is mounted rotatably in a recess in the spindle 26. The axes of the two journals 48, 50 of the eccentric shaft 46 are here preferably arranged on the common axis a.

The hollow pinion 40 may comprise a second hollow pinion portion 42 adjoining the first hollow pinion portion 44 in the insertion direction E of the tuning peg 20, which second hollow pin portion, like the first hollow pinion portion 44, is likewise provided with an external toothing. Both diameter and number of teeth of the second hollow pinion portion 42 are smaller than those of the first hollow pinion portion 44, however. The external toothing of the second hollow pinion portion 42 is in toothed engagement with a second internal gear toothing 52, which is formed preferably integrally with the spindle 26.

To tune a string not shown here of the stringed instrument, said string has to be introduced into the winding hole 28, if this has not already happened. The user of the stringed instrument then turns the peg handle 22 of the tuning peg 20. The peg handle 22, which is mounted rotatably on the component 34 comprising the first internal gear toothing 36, transmits the turning movement via the first journal 48 to the eccentric shaft 46. This in turn ensures by means of its eccentricity that the hollow pinion 40 is guided in a circular path about the common axis a. With this movement the external toothing of the first hollow pinion portion 44 engages in the first internal gear toothing 36, which is joined non-rotatably to the peg receiving portion 10, such that the hollow pinion 40 rests against the first internal gear toothing 36. The hollow pinion 40 thus performs an additional turning movement about the eccentric shaft 46.

At the same time, the teeth of the external toothing on the second hollow pinion portion 42 are in toothed engagement with the second internal gear toothing 52. The eccentric shaft thus drives the spindle 26, in which the second internal gear toothing 52 is formed, so changing the tension of the string.

Because of the different numbers of teeth on the first hollow pinion portion 44 and the first internal gear toothing 36 on the one hand and on the second hollow pinion portion 42 and the second internal gear toothing 52 on the other hand, the turning movement transmitted from the peg handle 22 to the spindle 26 is geared down markedly. In this exemplary embodiment the gearing down amounts to 1:19, which means that the peg handle 22 must be turned nineteen times in order to turn the spindle 26 once.

Despite this considerable gearing down, which is very favourable for precision tuning of the stringed instrument, the hollow pinion 40 transmitting the force and bringing about the gearing down, is sufficiently large, thanks to the configuration according to the invention of the tuning device, to ensure a long service life of the fine tuning peg.

1. A tuning device for adjusting the tension of one or more strings of a stringed instrument, with a peg receiving portion (10) which comprises pairs of bores (12, 14) for rotatably receiving tuning pegs (20), the tuning pegs (20) in each case comprising a peg body with a spindle (26) for insertion into a pair of bores (12, 14) in the peg receiving portion (10) and for winding up the end portion of a string and comprising a peg handle (22) joined to the spindle (26) for turning the spindle (26) about a common axis (a) of peg handle (22) and spindle (26), a gear mechanism (33) being provided outside the peg receiving portion (10) for function between the peg handle (22) and the spindle (26), which gear mechanism passes on to the spindle (26) a geared-down turning movement of the peg handle (22) about the common axis (a), characterised in that the gear mechanism (33) is an eccentric gear mechanism.

2. A tuning device according to claim 1,
characterised in that the eccentric gear mechanism (33) takes the form of a stepped eccentric gear mechanism.

3. A tuning device according to claim 1,
characterised in that the eccentric gear mechanism (33) comprises:
an eccentric shaft (46) turnable about the common axis (a) by means of a turning movement of the peg handle (22),
a hollow pinion (40) mounted rotatably on the eccentric shaft (46),
a first internal gear toothing (36) arranged non-rotatably relative to the peg receiving portion (10) and
a second internal gear toothing (52) arranged non-rotatably relative to the spindle (26),
wherein a first hollow pinion portion (44) of the hollow pinion (40) is in toothed engagement with the first internal gear toothing (36) and a second hollow pinion portion (42) of the hollow pinion (40) adjoining the first hollow pinion portion (44) in the direction of the common axis (a) is in toothed engagement with the second internal gear toothing (52).

4. A tuning device according to claim 3,
characterised in that the external toothing of the first hollow pinion portion (44) and the external toothing of the second hollow pinion portion (42) comprise different numbers of teeth.

5. A tuning device according to claim 3, characterised in that the difference in numbers of teeth between the first internal gear toothing (36) and the external toothing of the first hollow pinion portion (44) is equal to the difference in numbers of teeth between the second internal gear toothing (52) and the external toothing of the second hollow pinion portion (42).

6. A tuning device according to claim 3, characterised in that the peg handle (22) comprises a recess, in which a component (34) comprising the first internal gear toothing (36), and preferably also a component (26) comprising the second internal gear toothing (52), is or are at least partially accommodated.

7. A tuning device according to claim 1, characterised in that the eccentric gear mechanism (33) is self-locking.

8. A tuning device according to claim 1, characterised in that the eccentric gear mechanism (33) is designed to bring about gearing down of the turning movement between peg handle (22) and spindle (26) by 1:12 to 1:25, preferably by between 1:18 and 1:20, still more preferably by approx. 1:19.

9. A tuning device according to claim 1, characterised in that the eccentric gear mechanism (33) is made at least in part of plastics, in particular polyamide.

10. A tuning device according to claim 1, characterised in that the eccentric gear mechanism (33) is made at least in part of carbon fibre-reinforced material, wherein the carbon fibre content preferably amounts to between 30% and 50%, still more preferably to approx. 40%.

11. A tuning device according to claim 1, characterised in that a bearing housing (32), inserted, preferably pressed, into the bore (12) in the peg receiving portion (10) between the spindle (26) and the peg receiving portion (10) on the side of the peg receiving portion (10) close to the peg handle (22), is arranged non-rotatably relative to the peg receiving portion (10), and/or a bushing (30), inserted, preferably pressed, into the bore (14) in the peg receiving portion (10) between the spindle (26) and the peg receiving portion (10) on the side of the peg receiving portion (10) remote from the peg handle (22), is arranged non-rotatably relative to the peg receiving portion (10), wherein the spindle (26) is mounted in the bearing housing (32) and/or the bushing (30) so as to be turnable with the peg handle (22) about the common axis (a) of rotation.

12. A tuning device according to claim 11,
characterised in that the bearing housing (32) and/or the bushing (30) taper, preferably conically, in the direction (E) of insertion of the tuning peg (20) into the pair of bores (12, 14) in the peg receiving portion (10), the external diameter of the bearing housing (32) amounting to between approx. 12.5 mm and approx. 14.5 mm.

13. A tuning device according to claim 11, characterised in that a/the component (34) comprising the first internal gear toothing (36) is joined non-rotatably to the bearing housing (32) by means of a snap closure and/or by means of adhesive bonding.
